(19) United States
(12) Patent Application Publication
(10) Pub. No.: US 2006/0020987 A1
(43) Pub. Date: Jan. 26, 2006

(54) Broadcast receiver

(75) Inventors: Takehiro Onomatsu, Osaka (JP); Shusuke Narita, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/177,929

(22) Filed: Jul. 8, 2005

(30) Foreign Application Priority Data
Jul. 9, 2004 (JP) P2004-203131

(51) Int. Cl. H04N 7/173

(52) U.S. Cl. 725/100; 725/131

(57) ABSTRACT

When a new reception channel is to be added and set, a controller sequentially changes the reception direction for the directivity of a smart antenna and confirms the reception of a broadcast wave in each of the directions. When confirmation of the reception in all the directions has been completed, the controller determines, for the directivity of the smart antenna, in which of the directions the optimal reception and reproduction of the broadcast wave will be provided. When an appropriate direction for the directivity is present, the controller stores the thus determined direction in a channel setup table as part of the data for the channel that is being added. Thereafter, when this channel is selected for the reception of a TV broadcast, the direction determined for the directivity is set for the smart antenna.

### BACKGROUND OF THE INVENTION

1. Field of the Invention

The present invention relates to a broadcast receiver that receives, via a directivity switching antenna, a broadcast on a predetermined channel transmitted by a broadcast station.

2. Description of the Related Art

In order to improve the property for the reception of a broadcast wave, such as a television broadcast wave, according to one proposal an antenna for which a combination of a plurality of antenna devices can be changed by a switching circuit is connected to a television receiver (hereinafter referred to as a TV), and when the TV is powered on, or when a channel is changed, the signal received for the selected channel is examined while the combination of antenna devices is changed by the switching circuit, and when the best point for the received signal is detected, the switching circuit is fixed (e.g., JP-A-63-42581 (page 2, upper right column, line 13 to page 3, upper left column, line 18)). Another proposal is that when a combination of multiple antenna devices is changed by a switching circuit, channel numbers and a plurality of antenna devices that have been selected are displayed on the screen of a TV (e.g., JP-A-63-171029 (page 2, lower right column, line 15 to page 3, lower left column, line 11, FIG. 2)). However, since the directivity of an antenna is to be changed by varying the combination of multiple antenna devices, delicate adjustment of the directivity cannot be performed. Further, since within the range of 0° to 360° the directivity of the antenna cannot be changed in an environment wherein broadcast stations (or base stations) are scattered in all possible antenna directions, broadcasts by all stations cannot be received in a reception enabled state.

Thus, a further proposal provides for the changing of the amplitudes and the phases of electric waves received by a plurality of antenna devices to control the directivity of an antenna (e.g., JP-A-11-298226 (Paragraphs 0008 to 0016)). According to this proposal, when a television receiver is powered on, or when a channel is switched, to facilitate antenna directivity, scanning is performed in all directions, from 0° to 360°. In this way, a search can be made to determine in which direction the maximum reception power level is available, and for the antenna, the directivity is adjusted to keep the antenna pointed in this direction. Furthermore, such a television receiver also includes a manual setup mode that permits a user to confirm an image without ghosts and to adjust the antenna directivity. Thus, when a channel is changed following the selection, by the user, of the manual setup mode, the directivity of the antenna is set based on data stored in the memory while in the manual setup mode. Further, when the directivity is adjusted manually in the manual setup mode, data stored in the memory are updated based on data representing the adjusted directivity of the antenna.

### SUMMARY OF THE INVENTION

However, according to the proposals disclosed in JP-A-63-42581, JP-A-63-171029 and JP-A-11-298226, each time a channel is changed, a search (scanning) is performed to adjust the directivity of the antenna and to obtain the best picture. Therefore, once a channel has been changed, time is required to obtain the best image, a source of irritation for the user. This problem is not resolved by the proposition in JP-A-63-171029 that provides for the display on a screen of the selection state of the antenna devices. Further, even if the directivity of the antenna at which the best image can be obtained is set in the memory for each previously received channel, the directivity must be adjusted to receive a broadcast on a new channel for which no setting is stored in the memory. This is not explained in any of JP-A-63-42581, JP-A-63-171029 and JP-A-11-298226. The adjustment, in the manual setup mode, of antenna directivity is a process employed to search for the best point in the reception state while, to adjust the directivity, the direction of the antenna is sequentially changed manually. This is a tedious, demanding user task that is not always performed by all users.

To resolve the conventional shortcomings, one objective of the present invention is to provide a broadcast receiver wherein a new channel to be received can be easily added and set up, and wherein, when the added channel is selected, the best reception state for a broadcast wave can immediately be obtained by a directivity switching antenna.

According to one aspect of the invention, there is provided a broadcast receiver, which receives, via a directivity switching antenna for which the directivity can be changed to encompass a plurality of directions, broadcasts transmitted on reception channels by a plurality of broadcast stations, including: a controller, for changing the direction for the directivity of the directivity switching antenna and for controlling individual sections of the broadcast receiver; and a memory, for storing, in correlation with each other, channel information for individual reception channels and direction information indicating directions in which the directivity switching antenna is capable of receiving broadcasts on the reception channels. When a new channel is to be added and stored as a reception channel in the memory, the controller provides control for the reception of a broadcast being transmitted on the new channel, while changing to all possible directions the direction of the directivity switching antenna, and determines in which direction, of all the directions, the broadcast for the new channel can be received and reproduced under the best possible conditions, and stores in the memory, in correlation with each other, channel information for the new channel and direction information applicable to the thus determined direction. Further, when the new channel that has been added is selected, the controller reads the direction information for the new channel from the memory and uses the direction information to set the direction for the directivity of the directivity switching antenna. In this case, the channel information is typically a channel number.

As is described above, when a user designates a channel to be added, the controller changes the directivity of the directivity switching antenna to all possible directions and determines in which direction, of all the directions, the broadcast for the pertinent channel can be received and can be reproduced under the best possible conditions, and stores in (adds to) the memory channel information for the added channel and direction information indicating the thus determined direction. By employing this process, the setting up of the added reception channel can be automatically performed within a short period of time. And furthermore, when the channel that has been added is selected for the viewing of a broadcast, the controller can read from the memory the direction information correlated with the channel information for the channel, and can use the direction information to set the direction for the directivity of the directivity switching antenna, i.e., unlike in patent documents 1 to 3, a search (scan) is not performed to obtain the direction for the directivity of the antenna after the channel has been changed. Thus, a broadcast on the new channel can be accepted immediately, under the best possible conditions.

According to an embodiment of the invention, when the direction for the directivity switching antenna is changed, the controller displays, on a display unit, a message to that effect.

As described above, when the direction for the directivity is changed (scanned) during the reception of a broadcast, snow (video noise) tends to be displayed or audio noise tends to be output during the scanning. However, when, as described above, a message that the direction for the directivity is being changed is displayed on the display unit, a user can visually confirm that scanning is currently being performed, and this will prevent the user from becoming anxious and fearing that the broadcast receiver may have malfunctioned. It should be noted that the display unit is, for example, a television receiver monitor for a broadcast receiver that receives a television broadcast, or the display panel of a console unit for a television receiver that receives a radio broadcast.

According to another embodiment of the invention, there is provided a broadcast receiver, which receives via a smart antenna, for which directivity is to be changed to correspond to a plurality of predetermined directions, digital television broadcasts for channels transmitted by a plurality of broadcast stations, including: a controller, for changing a direction for the directivity of a smart antenna and for controlling individual sections of the broadcast receiver; and a memory, for storing, in correlation with each other, channel information for reception channels and direction information indicating directions, for the directivity of the smart antenna, in which digital television broadcasts for the reception channels are to be received. When a new channel is to be added and stored in the memory as a reception channel, the controller provides control for the reception of a digital television broadcast being transmitted on the new channel while changing to all possible directions the direction for the directivity of the smart antenna and determines in which direction, of all the directions, the broadcast for the new channel can be received and reproduced under the best possible conditions, stores in the memory channel information, including sub-channel information, for the new channel and channel direction information indicating the direction that has been determined, and when the direction for the directivity of the smart antenna is changed, displays a message to that effect on the television receiver. Furthermore, when a sub-channel of the new channel that has been added is selected, based on the channel information stored in the memory, the controller reads the direction information for the new channel from the memory, uses the direction information to set the direction for the directivity of the smart antenna, and displays, on the television receiver, a picture for the selected sub-channel. In this case, the channel information is typically a channel number, and includes sub-channel information. The sub-channel information includes a user channel number allocated for each sub-channel.

As described above, channel information that includes information for sub-channels of a channel to be added, and direction information that indicates in which direction, of all the directions available for the directivity of a smart antenna, a digital television broadcast for a channel to be added can be received and can be reproduced under the best possible conditions, are stored in (added to) the memory in correlation with each other. Therefore, by using a remote controller, a desired sub-channel can be easily selected based on the channel information stored in the memory, or more specifically, based on the sub-channel information. In addition, since the sub-channel information and the direction information are stored in the memory in correlation with each other, when a sub-channel is selected, the controller can read, from the memory, the direction information that indicates the direction for the directivity according to which a digital television broadcast for the selected sub-channel can be received under the best possible conditions, and can be used to set the direction information for the smart antenna. As a result, a picture included in the digital television broadcast on the selected sub-channel, having been received under the best possible conditions, can immediately be displayed on the television receiver. Furthermore, when the direction for the directivity of the directivity switching antenna is changed (scanned), a message to that effect is displayed on the television receiver, so that a user can visually confirm that scanning is currently being performed. With this arrangement, even when snow (video noise) is displayed during the scanning, an uneasy feeling that the broadcast receiver may have malfunctioned will not be communicated to a user.

According to this invention, the addition and setup of a new reception channel can be automatically performed within a short period of time, and when the new channel is selected for reception, abroad cast on the selected channel can immediately be received under the best possible reception conditions.

### BRIEF DESCRIPTION OF THE DRAWINGS

FIG. 1 is a block diagram showing a reception system for television broadcasting;

FIG. 2 is a diagram showing a direction for the directivity of a smart antenna;

FIGS. 3A and 3B are diagrams showing example channel setup tables;

FIG. 4 is a flowchart showing the channel addition processing;

FIGS. 5A and 5B are diagrams showing screens displayed on a television during the channel addition processing;

FIGS. 6A and 6B are diagrams showing screens displayed on the television during the channel addition processing; and

FIG. 7 is a diagram showing a screen displayed on the television during the channel selection processing.

### DETAILED DESCRIPTION OF THE PREFFERED EMBODIMENTS

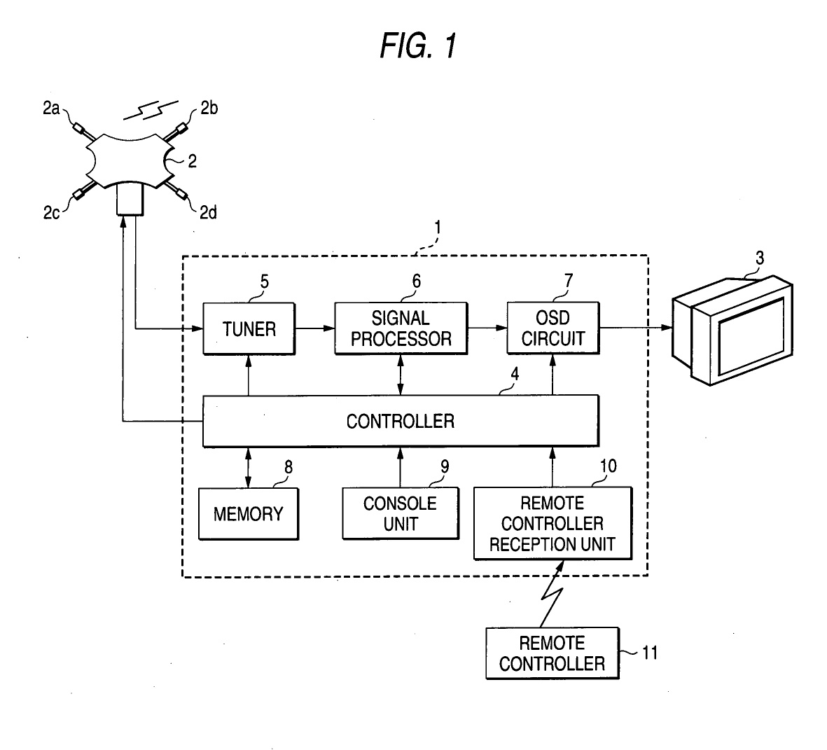

FIG. 1 is a block diagram showing a television broadcast (hereinafter referred to as a TV broadcast) reception system. A broadcast receiver 1 and a television receiver (hereinafter referred to as a TV 3) 3 are installed in an ordinary house and are connected by a cable. A smart antenna 2 is mounted on the roof of the house and is connected to the broadcast receiver 1 by a cable. The smart antenna 2 is an example antenna (hereinafter referred to as a directivity switching antenna) for which the directivity can be selected, and for this antenna, according to current standards, a direction for the directivity can be selected from among 16 directions available in the surrounding area. The smart antenna 2 includes four antenna devices 2a to 2d, and phase devices, synthesizing devices and control circuits (none of them shown, other than the antenna devices 2a to 2d) that correspond to the antenna devices 2a to 2d. The phases of signals received by the antenna devices 2a to 2d are controlled by the respective phase devices, and the signals whose phases are controlled are synthesized by the respective synthesizing devices, so that the direction for the directivity of the smart antenna 2 can be electrically changed to one of the 16 directions. In the following explanation, the broadcast receiver 1 is regarded as a broadcast receiver that receives a digital television broadcast.

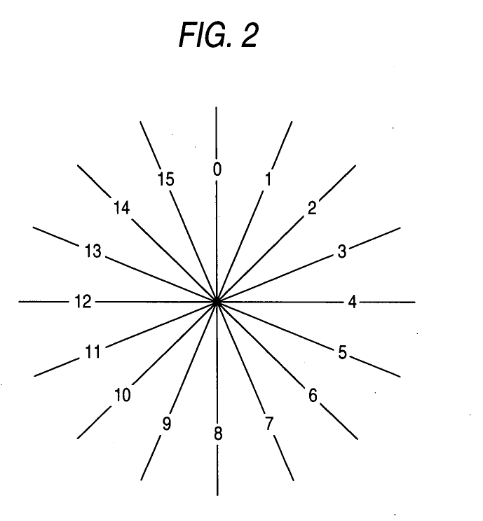

FIG. 2 is a diagram showing the available directions for the directivity of the smart antenna 2. Each straight line in FIG. 2 corresponds to a direction to which the directivity of the smart antenna 2 can be changed, and the point whereat the straight lines intersect corresponds to the center of the smart antenna 2. The numbers 0 to 15 are direction numbers used to designate directions for the directivity. That is, the direction for the smart antenna 2 directivity can be changed to one of 16 directions obtained by dividing the surrounding 360°. The broadcast receiver 1 (controller 4) controls the smart antenna 2, so that electric waves of digital television broadcasts transmitted by multiple broadcast stations can be received under the best possible conditions, i.e., changes to the optimal direction the directivity of the smart antenna 2.

The controller 4 includes a CPU, a ROM and a RAM. A control program and data are stored (set) in the ROM, and the numbers of channels (hereinafter referred to as reception available channels) for all the television broadcasts that can be received, and their signal frequency bands, are also stored in the ROM, in correlation with each other. When the broadcast receiver 1 and the smart antenna 2 are installed and connected by the cable, the controller 4 sets, in the control circuit of the smart antenna 2, the correlation information for the numbers of the reception available channels and the signal frequency bands. The control data are stored in the RAM so that they will be writable and readable. The controller 4 controls the individual sections of the broadcast receiver 1 in accordance with the control program, and switches the direction for the directivity of the smart antenna 2.

A tuner 5 extracts a television broadcast signal for a selected channel from among television broadcast waves received by the smart antenna 2. A signal processor 6 processes a television signal output by the tuner 5, generates a video signal and an audio signal, and outputs these signals to the TV 3. An OSD circuit 7 superimposes a picture data signal on the video signal, so that picture data output by the controller 4 can be displayed as an OSD (on-screen display) by the TV 3. The TV 3 processes the picture signal and the audio signal output by the OSD circuit 7, displays a picture on a monitor, and outputs audio through a loudspeaker. A console unit 9 includes various keys, such as a channel key, and a power switch. A remote controller 11 is provided with various keys, such as a channel key, an enter key and a cursor key, and when one of the keys is pressed, a signal corresponding to the pressed key is transmitted via a remote controller reception unit 10 to the controller 4.

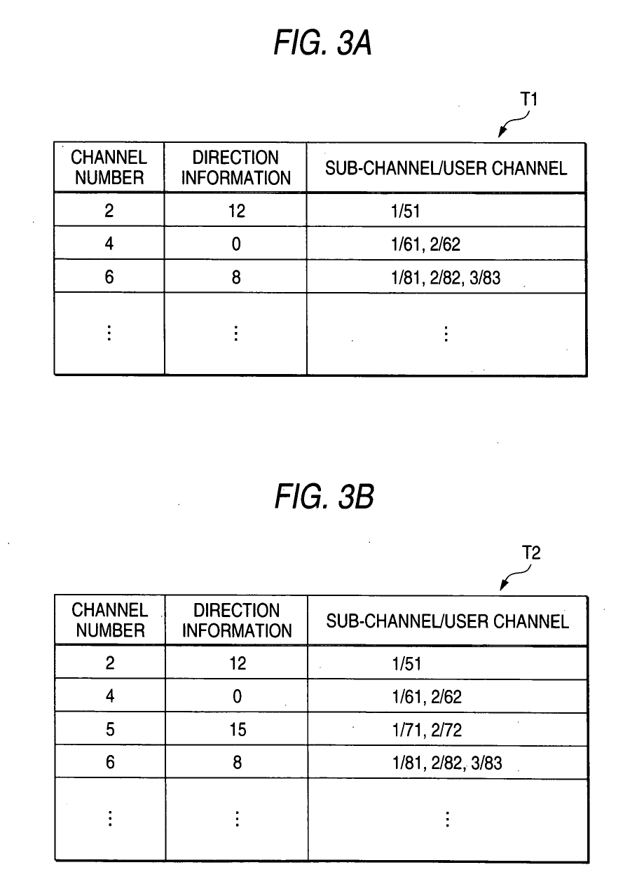

FIGS. 3A and 3B are diagrams showing example channel setup tables stored in a nonvolatile memory 8. A channel setup table T2 in FIG. 3B is a table obtained by adding, while employing a channel addition process that will be described later, information for channel number 5 to a channel setup table T1 in FIG. 3A. When the channel setup tables T1 and T2 need not be specified, a channel setup table T is defined. The channel setup table T is used when a TV broad cast is a digital TV broadcast; however, the same table is also employed for the reception of an analog TV broadcast, or the reception of both analog and digital TV broadcasts. The channel setup table T is generated by employing all the channel setup processes that are performed when the broadcast receiver is first installed. All the channel information, including channel numbers and sub-channels/user channels and direction information, are stored in the channel setup table T, in correlation with each other.

A channel number is the number (e.g., 2) of a channel for a digital TV broadcast received by the broadcast receiver 1, one of the reception available channels that are stored in the ROM. The direction information is information indicating the optimal direction for the directivity, of the smart antenna, in which the digital TV broadcast for the pertinent channel is received, i.e., is one of the direction numbers 0 to 15. The sub-channels/user channels will now be described. For digital TV broadcasting, separable broadcast signals for a plurality of sub-channels are included in a broadcast signal for one channel. Also, numbers (hereinafter referred to as user channel numbers), designated by the remote controller 11, that are used to select the individual sub-channels are also included in a broadcast signal for one channel. The user channel numbers for the sub-channels of the individual channels are entered in the sub-channel/user channel columns. The user channel numbers for the sub-channels are extracted by the signal processor 6 and transmitted to the controller 4.

In the channel setup table T, for example, the digital TV broadcast for channel number 4 includes sub-channels 1 and 2, and when the direction 0 is set for the directivity of the smart antenna 2, broadcasting is received under the best possible conditions and the user channel numbers of the sub-channels are 61 and 62. For an analog TV broadcast, there are no sub-channels. When a digital TV broadcast and an analog TV broadcast are to be received by the broadcast receiver 1, data indicating the digital and analog TV broadcast types may be included as channel information. In addition, during the all channel setup process, the numbers of reception available channels are sequentially read from the ROM, and when reception of the channels is enabled, the numbers of the channels, information for the directions in which the smart antenna 2 can receive the digital TV broadcasts for the channels under the best possible conditions, and the user channel numbers for the sub-channels are sequentially entered in the channel setup table T. Thus, the channel setup table T is generated.

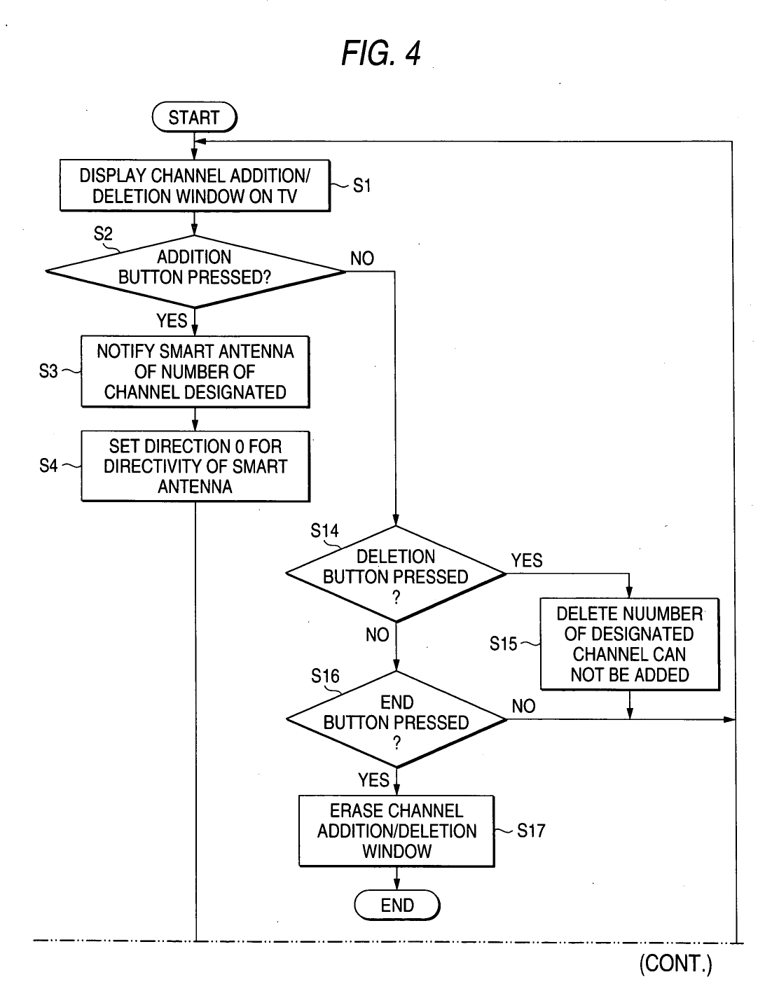

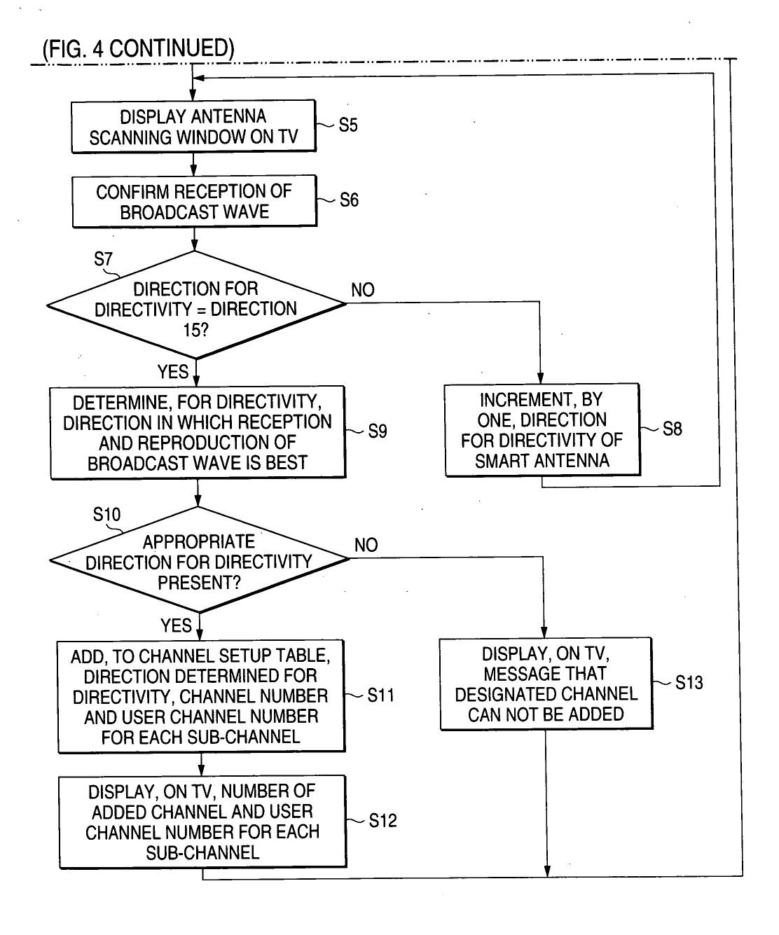

FIG. 4 is a flowchart showing the channel addition/deletion processing. The processing (S3 to S12), according to the invention, for adding a channel is called channel addition processing. This processing is performed when the controller executes a program stored in the ROM. It should be noted that the channel addition processing is the processing used to add a new reception channel to the channel setup table T. For example, during the all channel setup processing, the channel addition processing is performed when a channel, which has not been registered in the channel setup table T because the reception state for a broadcast signal was poor due to rain, is additionally entered in the channel setup table T as a reception channel.

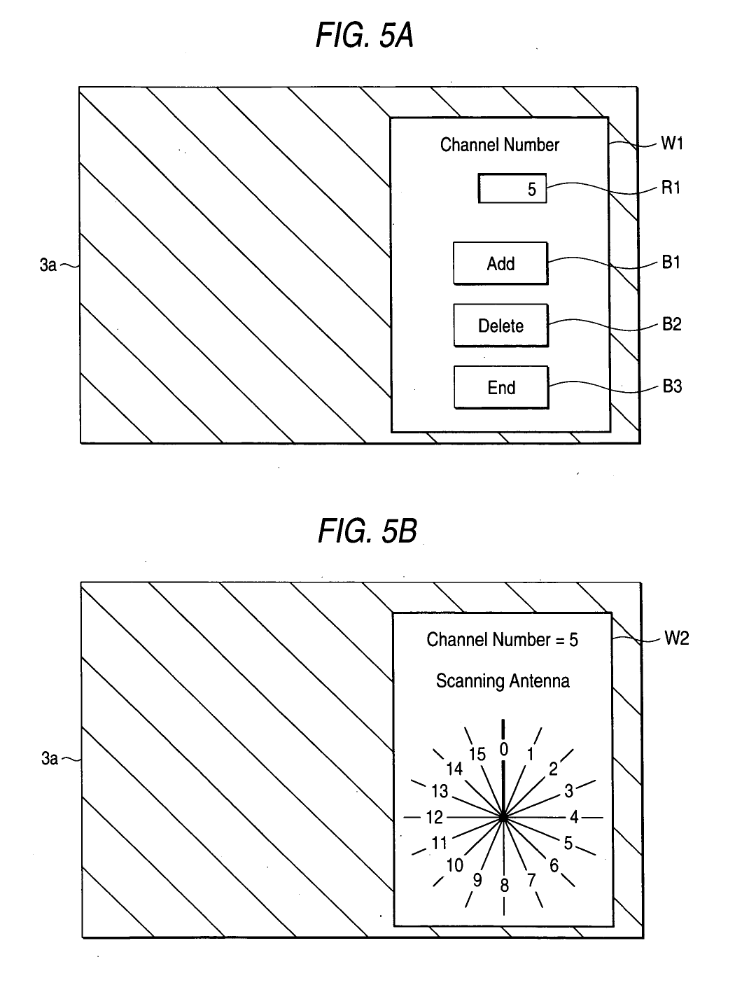

First, when a predetermined manipulation is performed using the remote controller 11, the controller 4 displays a channel addition/deletion window W1 in FIG. 5A as an OSD on a monitor 3a of the TV 3 (S1). In FIG. 5A, a shaded portion indicates the picture of a digital TV broadcast selected by the tuner 5. R1 represents an input area wherein the number of a channel to be added or deleted is entered, and “5” is entered in the input area R1 as the number of the channel to be added or deleted. B1 is an addition button for instructing the addition of a channel, B2 is a deletion button for instructing the deletion of a channel, and B3 is an end button for instructing the termination of the channel addition/deletion processing.

In this state, whether the addition button B1, the deletion button B2 or the end button B3 has been pressed by manipulating the remote controller 11 is repetitively examined (S1, S2, S14 and S16). When the deletion button B2 is pressed while the number of a channel to be deleted has been entered in the input area R1 (YES at S14), the controller 4 deletes the number of the designated channel from the channel setup table T (S15). At this time, the controller 4 displays on the monitor 3a, for about five seconds, a message stating that the channel has been deleted (not shown), and subsequently, again displays the channel addition/deletion window W1 on the monitor 3a (S1). Then, when the end button B3 is pressed (YES at S16), the controller 4 erases the channel addition/deletion window W1 (S17) and terminates the channel addition/deletion processing.

When the addition button B1 is pressed while the number of a channel to be added is entered in the input area R1 (YES at S2), the channel addition process is performed as follows. First, the controller 4 notifies the smart antenna 2 of the number of the designated channel (the channel to be added) (S3). Upon receiving the notification of the channel number, the smart antenna 2 sets the individual sections so that they can receive the electric wave for a frequency band consonant with the channel number. At this time, the tuner 5 performs tuning in accordance with the designated channel. Furthermore, the controller 4 transmits to the smart antenna 2 a control signal to change to direction 0 the direction for the directivity, and designates as direction 0 the direction for the directivity of the smart antenna 2 (S4).

Thereafter, as shown in FIG. 5B, the controller 4 displays an antenna scanning window W2 as an OSD on the monitor 3a of the TV 3 (S5). The direction of the directivity designated for the smart antenna 2 is displayed in the antenna scanning window W2. At this time, since the direction for the directivity is the direction 0, a thick line is displayed for direction 0. As will be described later, when the direction for the directivity of the smart antenna 2 is sequentially switched, the thick line displayed in the antenna scanning window W2 is moved (rotated) in correspondence with the direction for the directivity. This procedure makes it possible for a user to visually identify a situation during which the direction for the directivity of the smart antenna 2 is sequentially changed. The number of the designated channel can also be displayed in the antenna scanning window W2.

Then, the controller 4 confirms the reception of a broadcast wave in the state wherein the direction for the directivity of the smart antenna 2 is set to direction 0 (S6). Specifically, the controller 4 receives, from the signal processor 6, the reception level for the digital TV broadcast signal, the bit error rate and the user channel number for each sub-channel, and temporarily stores these data in the RAM for each direction for the directivity. When the reception signal level is equal to or lower than a predetermined reference value, data for the bit error rate is invalid. And when a bit error occurs in data for the user channel number, data for the user channel number is invalid.

When the direction for the directivity of the smart antenna 2 is not direction 15 (No at S7), the controller 4 designates, for the smart antenna 2, a direction for the directivity incremented by one (in this case, direction 2) (S8), and repeats the processes at S5 and S6 until the direction for the directivity reaches direction 15. That is, the direction for the directivity of the smart antenna 2 is sequentially changed, and the reception of a broadcast wave in all the directions for the directivity is confirmed. In this embodiment, the direction for the directivity is changed from direction 0 to direction 15 in the ascending order. However, the direction for the directivity may be changed in the opposite order.

When the direction for the directivity of the smart antenna 2 is direction 15 (YES at S7), i.e., when the confirmation of the reception of the broadcast wave in all the directions for the directivity has been completed, the controller 4 determines the direction for the directivity in which the digital TV broadcast can be reproduced and the broadcast wave can be received under the best possible conditions (S9). Specifically, the reception signal levels in sixteen directions for the directivity stored in the RAM and the bit error rates are examined. And the direction in which the reception level is equal to or higher than a predetermined reference value, in which a bit error does not occur in data for the sub-channel number, and in which the bit error rate is the smallest is determined as the best (the optimal) direction for the directivity of the smart antenna 2. In this case, “the digital TV broadcast can be reproduced” remark means that the picture of a broadcast signal is being displayed, in a satisfactory state, on the monitor 3a of the TV 3.

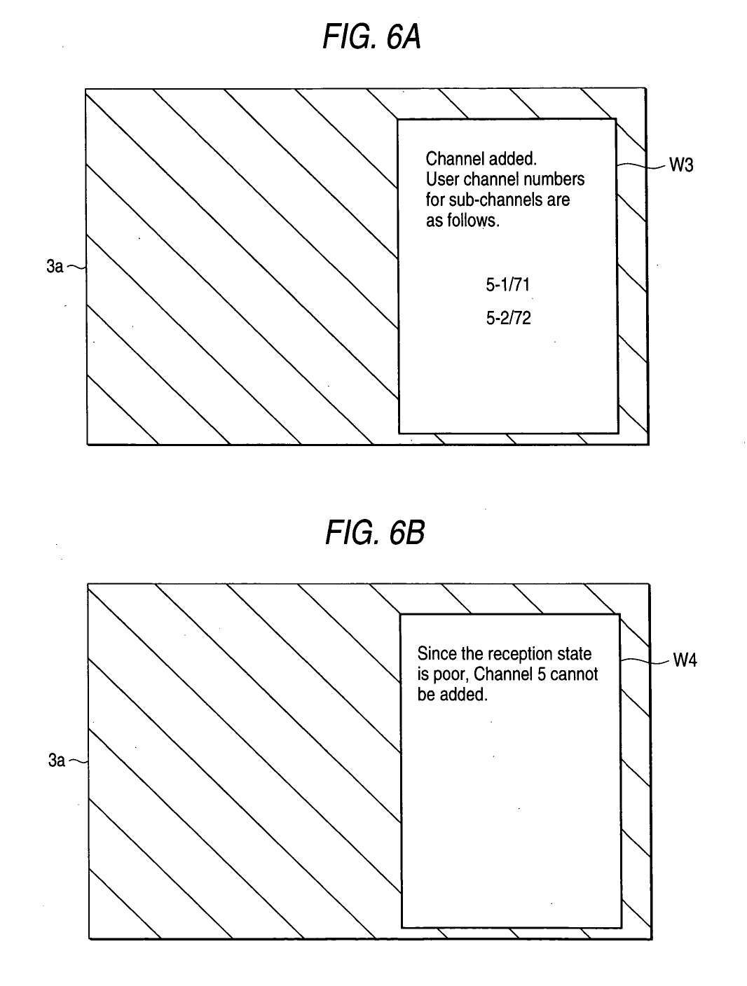

When an appropriate direction for the directivity (a direction for the directivity that satisfies the above condition) is present (YES at S10), the controller 4 enters in the channel setup table T the direction determined for the directivity of the smart antenna 2, the number of the designated channel (the channel to be added) and the user channel for each sub-channel, in correlation with each other (S11). For example, when channel number 5 is entered in the channel setup table T1, the channel setup table T1 is changed to the channel setup table T2. Furthermore, the controller 4 displays for about five seconds, as an OSD, an added channel information window W3, shown in FIG. 6A, on the monitor 3a of the TV (S12). The user channel numbers (“71” and “72”) for sub-channels (“1” and “2”) of the added channel (“5”) are displayed in the added channel information window W3. Thereafter, the controller 4 again displays the channel addition/deletion window W1 on the monitor 3a (S1), and repeats the processing at S2 to S13.

When an appropriate direction is not present (NO at S10), the controller 4 displays for about five seconds, as an OSD, a channel addition disabling window W4, shown in FIG. 6B, on the monitor 3a of the TV 3, so as to provide for the user a notification message that the designated channel can not be added (S13). Thereafter, the controller 4 again displays the channel addition/deletion window W1 on the monitor 3a (S1), and repeats the processing at S2 to S13.

As described above, during the channel addition processing, the controller 4 automatically and sequentially changes the direction for the directivity of the smart antenna 2, confirms the reception of a broadcast wave, and determines the direction for the directivity in which the broadcast wave can be received and the broadcast can be reproduced under the best possible conditions. When the appropriate direction for the directivity is present, the controller additionally enters, in the channel setup table T, the direction determined for the directivity, and the number of the designated channel and the user channel number for each sub-channel. In this manner, after a channel to be added has been designated and the addition button B1 has been pressed, the manual operation is not required, and as a result, the channel addition processing can be performed automatically, and in a short period of time.

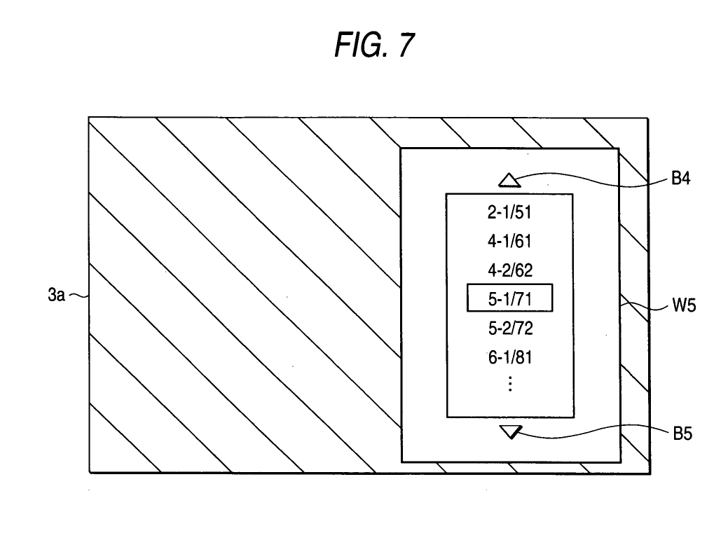

Furthermore, when the sub-channel of the added channel is selected by using the remote controller 11 to receive the broadcast wave for that channel, the controller 4 extracts, from the channel setup table T, the direction information that indicates a direction for the directivity of the added channel, and sets the direction information for the smart antenna 2. Therefore, the user can immediately accept a broadcast on the pertinent channel under the best possible reception conditions. At this time, since the controller 4 instructs the signal processor 6 to extract the selected sub-channel signal from the received signal, the picture for the sub-channel is displayed on the monitor 3a of the TV 3, and audio for the sub-channel is released through the loudspeaker. It should be noted that selection of a sub-channel is performed when the user channel number for each sub-channel is designated by using the remote controller 11. Either this, or a selection window W5 in FIG. 7 may be displayed as an OSD on the monitor 3a of the TV 3 by performing a predetermined manipulation of the remote controller 11, and two triangular channel move buttons B4 and B5 may be pressed to select the sub-channel. In FIG. 7, for channel 5, sub-channel 1 is selected.

In this embodiment, the broadcast receiver 1 to which the smart antenna 2 is connected has been explained. However, a directivity switching antenna is not limited to the smart antenna. The present invention can also be applied for a broadcast receiver to which, as in patent document 3, is connected an antenna for which the directivity can be electrically changed to correspond to a plurality of directions, or an antenna for which the directivity can be changed by physically rotating an antenna device.

Further, in this embodiment, the broadcast receiver has received digital TV broadcasts. The present invention, however, can also be applied for the reception of analog TV broadcasts, radio broadcasts and satellite broadcasts. And when, as for analog TV broadcasting, the concept of a bit error for a reception signal does not exist, whether the reception state will be good is determined solely by depending on a reception signal level.

What is claimed is:

1. A broadcast receiver, which receives via a smart antenna, for which directivity is to be changed to correspond to a plurality of predetermined directions, digital television broadcasts for channels transmitted by a plurality of broadcast stations, comprising:
a controller, for changing a direction for the directivity of the smart antenna and for controlling the broadcast receiver; and
a memory, for storing, in correlation with each other, channel information for reception channels and direction information indicating directions, for the directivity of the smart antenna, in which digital television broadcasts for the reception channels are to be received;
wherein, when a new channel is to be added and stored in the memory as a reception channel, the controller provides control for the reception of a digital television broadcast being transmitted on the new channel while changing to all possible directions the direction for the directivity of the smart antenna, determines in which direction, of all the directions, the broadcast for the new channel can be received and reproduced under the best possible conditions, stores in the memory channel information, including sub-channel information, for the new channel and channel direction information indicating the direction that has been determined, and when the direction for the directivity of the smart antenna is changed, displays a message to that effect on the television receiver; and
when a sub-channel of the new channel that has been added is selected, based on the channel information stored in the memory, the controller reads the direction information for the new channel from the memory, uses the direction information to set the direction for the directivity of the smart antenna, and displays, on the television receiver, a picture for the selected sub-channel.

2. A broadcast receiver, which receives, via a directivity switching antenna for which the directivity can be changed to encompass a plurality of directions, broadcasts transmitted on reception channels by a plurality of broadcast stations, comprising:
a controller, for changing the direction for the directivity of the directivity switching antenna and for controlling the broadcast receiver; and
a memory, for storing, in correlation with each other, channel information for individual reception channels and direction information indicating directions in which the directivity switching antenna is capable of receiving broadcasts on the reception channels;
wherein, when a new channel is to be added and stored as a reception channel in the memory, the controller provides control for the reception of a broadcast being transmitted on the new channel while changing to all possible directions the direction of the directivity switching antenna, determines in which direction, of all the directions, the broadcast for the new channel can be received and reproduced under the best possible conditions, and stores in the memory, in correlation with each other, channel information for the new channel and direction information applicable to the thus determined direction; and
when the new channel that has been added is selected, the controller reads the direction information for the new channel from the memory and uses the direction information to set the direction for the directivity of the directivity switching antenna.

3. The broadcast receiver according to claim 2, wherein, when the direction for the directivity switching antenna is changed, the controller displays, on a display unit, a message to that effect.
